(19) United States
(12) Patent Application Publication
(10) Pub. No.: US 2014/0205925 A1
(43) Pub. Date: Jul. 24, 2014

(54) Fuel Cell System

(71) Applicants: Thomas Baur, Weilheim (DE); Cosimo Mazzotta, Ulm (DE); Hans-Joerg Schabel, Reutlingen (DE)

(72) Inventors: Thomas Baur, Weilheim (DE); Cosimo Mazzotta, Ulm (DE); Hans-Joerg Schabel, Reutlingen (DE)

(73) Assignee: Daimler AG, Stuttgart (DE)

(21) Appl. No.: 14/237,049

(22) PCT Filed: Jul. 21, 2012
(86) PCT No.: PCT/EP2012/003089

§ 371 Date: Feb. 4, 2014

(30) Foreign Application Priority Data
Aug. 5, 2011 (DE) 10 2011 109 645.4

(51) Int. Cl. H01M 8/04

(52) U.S. Cl. CPC H01M 8/04007
USPC 429/434

(57) ABSTRACT

A fuel cell system includes at least one fuel cell, water-conducting parts and components in the region of the supply and discharge of starting materials and products to and from the fuel cell, and at least one cooling circuit containing liquid cooling medium for cooling the fuel cell. The water-conducting parts and components are in thermal contact with the cooling medium, at least during individual operating phases of the fuel cell.

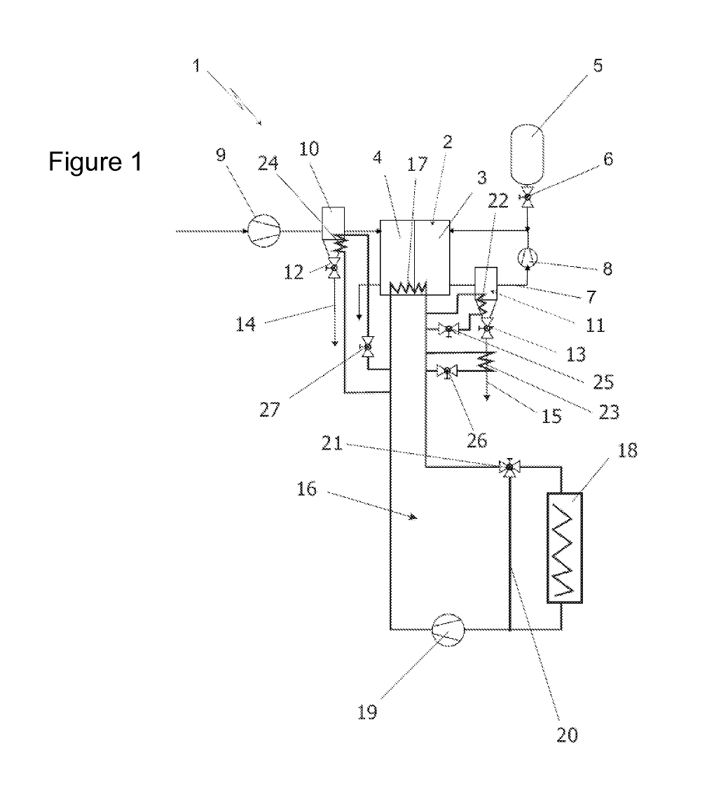

### BACKGROUND OF THE INVENTION

Exemplary embodiments of the invention relate to a fuel cell system having at least one fuel cell and to the use of a fuel cell system.

Fuel cell systems are known from the general prior art. Fuel cell systems frequently have fuel cells designed in the form of so-called PEM fuel cells. Such fuel cell systems are preferably used in mobile applications, such as in motor vehicles, for at least partially generating the electrical propulsion energy. In these types of fuel cell systems it is customary for various system components, for example an air supply subsystem, a fuel supply subsystem, and the like to be present. Since, in principle, product water occurs in the region of the fuel cell and must be discharged, fuel cell systems of this type generally have at least one, but typically multiple, water separator(s) for separating liquid water, present in the form of droplets, from gas flows from and/or to the fuel cell. These water separators are generally equipped with water lines for discharging the water, for example for reuse within the fuel cell system, or for discharging it outside the fuel cell system.

It is also known that the use of fuel cell systems, in particular in vehicles, also frequently occurs under adverse external conditions. Thus, for example, in vehicles it is necessary that they can be quickly and reliably started, even at temperatures below the freezing point. Various techniques are known for this purpose which are used, for example, so that the fuel cell itself heats up very quickly. For example, German Unexamined Patent Application DE 10 2004 017 434 A1 describes a fuel cell, a so-called fuel cell stack, which is designed in such a way that it has a cooling system for discharging excess waste heat during regular operation. The cooling system is designed in such a way that in the case of a cold start of the fuel cell system under adverse temperature conditions, the coolant flows through only a comparatively small number of single fuel cells of the fuel cell stack, the coolant accordingly heating up quickly. As the coolant heats, additional single cells are connected in and coolant flows through them. This serves to rapidly heat the coolant, and may thus ensure rapid heating of the fuel cell stack.

It is also known from the further general prior art to design a cooling circuit for the fuel cell system in such a way that in the cold start case, a bypass of the cooling heat exchanger is provided for removing the heat from the cooling circuit, so that the cooling circuit itself is heated more rapidly. To assist in this process, an additional heating element such as an electric heater may also be provided in the cooling circuit.

It is also known that water occurring in the fuel cell is generated during the electrochemical process, and consequently is pure. Therefore, this water freezes very quickly at temperatures below the freezing point, which cannot be prevented even with additives or the like, since the water does not form from the supplied starting materials until the fuel cell is in operation. Since the liquid water cannot be completely flushed from all water-conducting parts and components when the fuel cell system is switched off, it is often necessary to thaw water-conducting components in the fuel cell when the fuel cell system is started at temperatures below the freezing point. For this purpose, electric heating elements are generally provided in the region of the water-conducting parts and components, for example in the region of water separators. However, these electric heating elements require a comparatively large quantity of electrical energy when the fuel cell system is started. If this is a fuel cell system that is used, for example, in a vehicle as a mobile fuel cell system, energy is typically not available or is available only to a very limited extent, since the vehicle, like a conventional vehicle, often has only a starter battery for starting the system. The energy necessary for thawing the water-conducting parts and components thus places a significant load on the system during the start phase, and requires high-capacity electrical energy store units as an absolute necessity, thus making the design correspondingly heavy, large, and costly.

German patent document DE 10 2009 013 776 A1 describes a cooling device for a fuel cell system, in particular for a fuel cell system in a vehicle. The cooling device includes two cooling circuits, a low-temperature cooling circuit and a high-temperature cooling circuit. Part of the high-temperature cooling circuit is a heat exchanger in the region of the fuel cell itself the removes the waste heat from the fuel cell. In addition, a hydrogen recirculation blower, by means of which the electric drive motor must be cooled, may be part of the cooling circuit. In the cold start case, the hydrogen recirculation blower is then also heated by the cooling medium that is heating up in the fuel cell. Frozen water is thus thawed in the region of the blower as necessary.

Exemplary embodiments of the present invention avoid this problem by using a fuel cell system designed in such a way that it ensures rapid and reliable starting of the fuel cell system at temperatures below the freezing point and has comparatively low energy consumption.

The approach according to the invention provides that the water-conducting parts and components are in thermal contact with the cooling medium, at least during individual operating phases of the fuel cell. Instead of the electrical heating of the parts and components that conduct liquid water that may be frozen, in the fuel cell system according to the invention the heating is carried out in such a way that these components are brought into thermal contact with the cooling medium of the cooling circuit of the fuel cell system. Since the cooling circuit of the fuel cell itself is typically heated very quickly via appropriate measures, such as those explained at the outset, to ensure rapid starting of the fuel cell itself, a temperature above the freezing point is present comparatively quickly in the region of the cooling circuit, which may be utilized for thawing the corresponding water-conducting components, for example water separators and water discharge lines. This conserves energy for electrical heating of these components. The energy, which is present in the cooling water comparatively quickly, is totally sufficient for thawing the critical water-conducting parts and components, so that after the fuel cell itself is sufficiently heated to be ready for operation, it is also able to provide a fuel cell system that is ready for operation.

In one advantageous refinement of the fuel cell system according to the invention, the water-conducting parts and components have heat exchangers through which the cooling medium flows. These heat exchangers, which according to one advantageous refinement of the concept may be designed in the form of double-walled components or parts through which cooling water flows in the space thereof between the inner wall and the outer wall, thus allow very direct contact with the cooling medium, so that thawing of the components may take place easily and efficiently.

In another very advantageous embodiment of the fuel cell system according to the invention, the fuel cell system has a high-temperature cooling circuit and a low-temperature cooling circuit, the water-conducting parts and components being in thermal contact with the cooling medium of the high-temperature cooling circuit. This design makes use of the high-temperature cooling circuit, which typically includes the fuel cell and which heats to a comparatively high temperature level relatively quickly to achieve rapid heating of the fuel cell as well as thawing of the water-conducting parts and components. This design is particularly efficient, since, due to the higher temperature level of the high-temperature cooling circuit compared to the low-temperature cooling circuit, efficient thawing of the water-conducting parts and components may be achieved.

In another very advantageous embodiment of the fuel cell system according to the invention, the cooling circuit is switchable in a first operating mode so that the cooling circuit circulates only in at least a portion of the fuel cell and at least one of the water-conducting parts and components. Thus, in a quick start of the fuel cell system in which the cooling medium circulates only in the fuel cell itself and optionally in some additional peripheral parts that generate heat, for example, the one or multiple water-conducting parts and components may be included. Thus, the cooling water flows through these water-conducting parts and components immediately after the system starts, so that rapid and reliable thawing of the system may be ensured.

As previously mentioned, the particularly preferred use of the fuel cell system according to the invention lies in being able to start the fuel cell system very easily and efficiently, so that little energy, which previously had to be stored in an energy store, is required for thawing the water-conducting components. This results in a very simple and energy-efficient system particularly suited for use under adverse environmental conditions, for example for starting at temperatures below the freezing point. The use of the fuel cell system according to the invention is therefore preferably to be provided in vehicles that are frequently exposed to such adverse environmental conditions, and in which the energy necessary for starting the system may be provided only with a significant level of effort.

Further advantageous embodiments of the fuel cell system according to the invention and its use are made clear based on the exemplary embodiment explained in greater detail below with reference to the figure.

### BRIEF DESCRIPTION OF THE DRAWING FIGURES

The sole figure shows a fuel cell system according to the invention.

### DETAILED DESCRIPTION

The sole figure illustrates a fuel cell system 1 according to the invention. The fuel cell system includes a fuel cell 2 having an anode region 3 and a cathode region 4. The anode region 3 of the fuel cell 2 is supplied with hydrogen from a compressed gas store 5 via a throttle valve 6. The unconsumed exhaust gas from the region of the anode chamber 3 passes via a recirculation line 7 and a recirculation conveying unit 8 back into the region of the anode chamber 3, which is resupplied with this hydrogen together with fresh hydrogen from the compressed gas store 5. This design is also generally known as an anode loop, and for the exemplary embodiment illustrated here is understood to be strictly an example. In principle, it would also be conceivable to provide the fuel cell 2 without an anode loop, for example as a dead-end fuel cell, or with discharge of the unconsumed exhaust gas to a catalytic burner or the like, for example.

The cathode chamber 4 of the fuel cell 2 is supplied with filtered fresh air as an oxygen supplier via an air conveying unit 9. This supplied fresh air may, for example, flow through a humidifier, which is not illustrated but known in a manner per se, to be appropriately dehumidified and so as not to unnecessarily dry out the polymer electrolyte membranes separating the cathode chamber 4 from the anode chamber 3.

The fuel cell 2 itself then delivers electrical power and generates product water, which is discharged in the region of the exhaust gas flow. Since the design of the anode chamber 3 and of the cathode chamber 4 typically comprises a plurality of small gas-conducting channels that supply the starting materials to the polymer electrolyte membranes, the introduction of water into this region should absolutely be prevented, since water may thus clog the channels. For this reason, water separators that separate this liquid water from the product flow and starting material flow and conduct the water in liquid form from the system are provided at various locations in such a fuel cell system 1. Strictly as an example, two water separators 10, 11 are indicated in the exemplary embodiment of the fuel cell system 1 illustrated here, and are respectively connected via a valve 12, 13 to a water line 14, 15.

Since waste heat develops in the fuel cell 2 in addition to the product water and the exhaust gases, the fuel cell system 1 also has a cooling circuit 16. By means of a heat exchanger 17, this cooling circuit 16 cools the fuel cell 2 via a liquid cooling medium, and delivers the heat collected by the cooling medium during regular operation to the environment via a cooling heat exchanger 18. For this purpose, the liquid cooling medium is circulated in the cooling circuit 16 by means of a coolant conveying unit 19. The cooling circuit 16 for cooling the fuel cell 2 may include further peripheral parts and components to be cooled, as is known from the general prior art and is customary. These peripheral parts and components are not depicted here in order to simplify the illustration. The cooling circuit 16 typically also includes a bypass 20 of the cooling heat exchanger 18 that may be switched via a valve unit 21 in such a way that in the cold start case of the fuel cell 2, the cooling medium does not flow through the cooling heat exchanger 18, and accordingly is not cooled. The fuel cell 2 and the overall fuel cell system 1 are thus heated more rapidly, and more quickly reach the required operating temperature for starting the fuel cell system 1. This is also known from the general prior art.

In the embodiment illustrated here, the fuel cell system 1 now also has additional heat exchangers 22, 23, 24, of which three are indicated here by way of example. These heat exchangers 22, 23, 24 are situated in parts and components that conduct liquid water, and which are not cooled in the designs according to the prior art. As an example, the heat exchanger 22 here is situated in the region of the water separator 11, the heat exchanger 23 is situated in the region of the water discharge line 15, and the heat exchanger 24 is situated in the region of the heat exchanger 10. Further parts and components which conduct or which are contacted by water, such as humidifiers, turbines, valves, throttling points, throttle valves, filter cartridges, and recirculation blowers, could likewise be provided with heat exchangers of this type.

In the design of the fuel cell system 1 described here, these parts and components, which are not cooled in the prior art, are now connected to the cooling circuit 16 via the heat exchangers 22, 23, 24 and optional valve units 25, 26, and 27, respectively, in such a way that the cooling medium in the cooling circuit 16 may continuously flow through these heat exchangers, or, when the valve units 25, 26, 27 are present, may flow through as needed. In principle, cooling of the described water-conducting parts and components 10, 11, 15 is not necessary during regular operation, but could possibly be advantageous as an additional ancillary effect, at least in the region of the water separators 10, 11, since the rate of condensation could thus be increased.

However, the operation of the heat exchangers 22, 23, and 24 is provided primarily for the cold start case of the system. Accordingly, these heat exchangers are integrated into the portion of the cooling circuit 16 that is already operated in the cold start case, even when the liquid cooling medium does not flow through the cooling heat exchanger 18. When the fuel cell system 1 is started, the fuel cell 2 is heated in a manner known per se by starting the fuel cell 2. The cooling water of the fuel cell likewise heats comparatively quickly, in particular when all of the liquid cooling medium is led only through the bypass 20 and not through the cooling heat exchanger 18. In these situations, the cooling medium, which is already heated, flows through the heat exchangers 22, 23, and 24. If the fuel cell system 1 has remained at temperatures below the freezing point prior to starting, this may result in freezing of this water in the region of the water separators 10, 11 and the water discharge lines 15, 14. The lines are accordingly clogged, and cannot be used during starting of the fuel cell system 1, resulting in malfunctions of the system. However, due to the option of now being able to bring these parts and components, which otherwise are not cooled, into contact with the warm cooling medium in the cooling circuit 16, these components may be easily and efficiently thawed. This is possible due to the cooling water heating up comparatively quickly in a time period which is sufficient until these components must provide their full functionality. The energy input is much more energy-efficient compared to thawing using electric heating elements that are known in the region of these components from the prior art, so that a much lower quantity of energy has to be reserved for starting the fuel cell system 1, which in turn minimizes the size and costs of energy store units.

After the water-conducting components 10, 11, 15, which in the exemplary embodiment illustrated here are connected to the heat exchangers 22, 23, 24, are appropriately thawed, the heat exchangers 22, 23, 24 may be switched off to reduce the pressure losses in the cooling circuit 16 by closing the optional valve units 25, 26, 27, so that these heat exchangers are no longer part of the cooling circuit, and accordingly the liquid cooling medium does not have to flow through them. A decision must be made as to whether the level of effort for control and installation space for the valve units 25, 26, 27 justifies the reduction in the pressure losses in this region of the cooling circuit. Alternatively, it would be conceivable for the flow to simply continuously pass through the heat exchangers 22, 23, 24 during regular operation, since cooling or optionally also heating of the separators 10, 11 and of the water discharge line 15 to the temperature level of the cooling circuit 16 is not critical for regular operation of the fuel cell.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A fuel cell system, comprising:
at least one fuel cell;
water-conducting parts and components arranged in a region of supply and discharge of starting materials and products to and from the fuel cell; and
at least one cooling circuit containing liquid cooling medium for cooling the fuel cell,
wherein the water-conducting parts and components are in thermal contact with the cooling medium, at least during individual operating phases of the fuel cell.

12. The fuel cell system according to claim 11, wherein the water-conducting parts and components have heat exchangers, through at least parts of which the cooling medium flows.

13. The fuel cell system according to claim 12, wherein the water-conducting parts and components have, at least in part, a double-walled design, and wherein the double walls are used as heat exchangers.

14. The fuel cell system according to claim 11, further comprising:
valve units configured to switch the water-conducting parts and components into and out of the cooling circuit.

15. The fuel cell system according to claim 11, wherein the water-conducting parts and components include water separators.

16. The fuel cell system according to claim 11, wherein the water-conducting parts and components include water-conducting line elements.

17. The fuel cell system according to claim 11, wherein the cooling circuit is a high-temperature cooling circuit and the fuel cell system further comprises a low-temperature cooling circuit, wherein the water-conducting parts and components are in thermal contact with the cooling medium of the high-temperature cooling circuit.

18. The fuel cell system according to claim 17, wherein the high-temperature cooling circuit cools at least the fuel cell.

19. The fuel cell system according to claim 11, wherein the cooling circuit is configured so that it is switchable in a first operating mode in which the cooling circuit circulates only in at least a portion of the fuel cell and at least one of the heat exchangers of the heat-conducting parts and components.

20. A method of operating a fuel cell system comprising at least one fuel cell, water-conducting parts and components arranged in a region of supply and discharge of starting materials and products to and from the fuel cell, and at least one cooling circuit containing liquid cooling medium for cooling the fuel cell, the method comprising:
controlling the fuel cell system such that the water-conducting parts and components are in thermal contact with the cooling medium, at least during individual operating phases of the fuel cell.

21. The method of claim 20, wherein the control of the fuel cell system is achieved by switching valve units so that the water-conducting parts and components are changed from a state in which the water-conducting parts and components are not part of the cooling circuit into a state in which water-conducting parts and components are part of the cooling circuit.

22. The method according to claim 20, wherein the cooling circuit is switchable into and out of in a first operating mode in which the cooling circuit circulates only in at least a portion of the fuel cell and at least one of the heat exchangers of the heat-conducting parts and components.
